(19) United States
(12) Patent Application Publication
(10) Pub. No.: US 2026/0056732 A1
(43) Pub. Date: Feb. 26, 2026

(54) COMPUTER-IMPLEMENTED METHOD, COMPUTER PROGRAM PRODUCT AND COMPUTER SYSTEM FOR CONFIGURING SOFTWARE PACKAGES

(71) Applicant: Accenture Global Solutions Limited, Dublin (IE)

(72) Inventors: Kapil SINGI, Bangalore (IN); Manish AHUJA, Bangalore (IN); Ravi Kiran VELAMA, Bangalore (IN); Aimee G. TANANGONAN, Bulacan (PH); Vikrant KAULGUD, Bangalore (IN); Emmanuel Benbinuto ANTONIO, Mandaluyong (PH); Silvia Strümper, Mannheim (DE)

(21) Appl. No.: 18/812,854

(22) Filed: Aug. 22, 2024

(51) Int. Cl. G06F 8/71

(52) U.S. Cl. CPC G06F 8/71

(57) ABSTRACT

Methods, systems, and computer-readable storage media for generating configuration templates. For generating the configuration templates, conversational queries are generated. Based on conversational responses to the conversational queries, a task context and a task intent are determined using a first foundation model to identify software packages to be configured to perform tasks. Based on the task context, the task intent, and the conversational responses, a workflow template is generated using a second foundation model. Further, based on conversational responses, configuration fields of the workflow template for subtasks of each task are refined using a third foundation model. Based on the configuration fields of the workflow template, configuration fields of the configuration template for each task are generated using a fourth foundation model.

### FIELD OF THE INVENTION

Various embodiments described herein relate generally to computer-implemented method, computer system, and computer program product for configuring software packages.

### BACKGROUND

In the contemporary business environment, enterprises increasingly depend on intricate software applications to optimize operational efficacy and enhance productivity. The imperative for meticulously tailored and efficient software configurations has intensified due to a necessity for organizations to sustain competitiveness and agility amidst a rapidly evolving digital landscape.

### SUMMARY

Implementations of the present disclosure are generally directed to configuration of software packages using configuration templates. The software packages are configured using multiple foundation models, which are collaborated and operated in conjunction with each other. Leveraging the foundation models for configuring the software templates reduces time and effort required by users and subject matter experts to configure the software packages and minimizes errors that may generate during the configuration. Thereby, the proposed implementation democratizes software configuration, making it accessible, efficient, and tailored to specific requirements for enterprises.

In general, innovative aspects of the subject matter described in this specification provide a method for generating configuration templates. The method includes generating one or more conversational queries. The method includes determining a task context and task intent based on one or more conversational responses to the one or more conversational queries. The method includes identifying a set of software packages to configure. The set of software packages are configured to perform one or more tasks. The method includes generating a workflow template for configuring a software package from the set of software packages. The workflow template is generated based on the task context, task intent, and the one or more conversational responses. The method includes refining configuration fields of the workflow template for subtasks of each task based on the one or more conversational responses. The method includes generating configuration fields of the configuration templates for each task. The entities are generated based on configuration templates for the subtasks and the one or more conversational responses for output.

The present disclosure further describes systems for implementing the method provided herein. The present disclosure also describes computer-readable storage media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DRAWINGS

Various embodiments in accordance with the present disclosure will be described with reference to the drawings, in which:

FIG. 1 depicts an example environment that may be used to execute implementations of the present disclosure.

FIG. 2 depicts an example architecture of a configuration system for generating configuration templates and configuring software packages using the configuration templates in accordance with implementations of the present disclosure.

FIG. 3 depicts a block diagram that presents an example of a software identifier including components for identifying software packages to be configured using a first foundation model in accordance with implementations of the present disclosure.

FIG. 4 is a block diagram that presents an example of a workflow template generator including components for generating a workflow template using a second foundation model in accordance with implementations of the present disclosure.

FIG. 5 is a block diagram that presents an example of a configuration template generator including components for refining configuration fields of the workflow template using a third foundation model in accordance with implementations of the present disclosure.

FIG. 6 is a block diagram that presents an example of a package configuration manager including components for generating a configuration template and configuring the software package using a fourth foundation model in accordance with implementations of the present disclosure.

FIG. 7 depicts an example illustration of configuring software packages in accordance with implementations of the present disclosure.

FIG. 8 is a flow diagram that presents an example method for generating workflow templates in accordance with implementations of the present disclosure.

FIG. 9 illustrates a computer system that may be used to implement the configuration system.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example,” “an example of,” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

With the advent of technology, implementation of software applications has significantly grown, with enterprises increasing reliance upon latest software solutions to drive efficiency and production. For example, manual processes have now paved way to complex portals or platforms, requiring multiple add-ins and links, to manage various aspects of the enterprises. A few well-known examples of such platforms may include payments and reward management platforms, attendance and leave management platforms, official communication management platforms, and so forth.

Configuring software packages, typically being a manual process, is time-consuming and costly since it involves manual effort to identify the software packages and accurately configure the software packages. Additionally, it is difficult to mitigate manual errors occurred while configuring the software packages, due to which the configuration process exceeds scheduled timelines for removal of bugs.

Additionally, since each software may pertain to its own predefined functionality, configuring the software requires specific domain knowledge, which may be scarcely available. Therefore, the configuration process becomes increasingly dependent on availability of subject matter experts (SME) and may get delayed due to their unavailability.

In view of this, implementations of the present disclosure leverage collaborative foundation models to orchestrate the configuration of software packages. Each foundation model is trained to perform a specific task pertaining to the configuration of the software packages. Also, inter-communication between the foundation models, such that each foundation model is providing output to a succeeding model and obtaining feedback from a preceding model, increases accuracy and efficiency of the configuration process. Also, the implementations of the present disclosure mitigate reliance on manual processes, which are disparate, cost and time consuming, and highly dependent on subject matter experts.

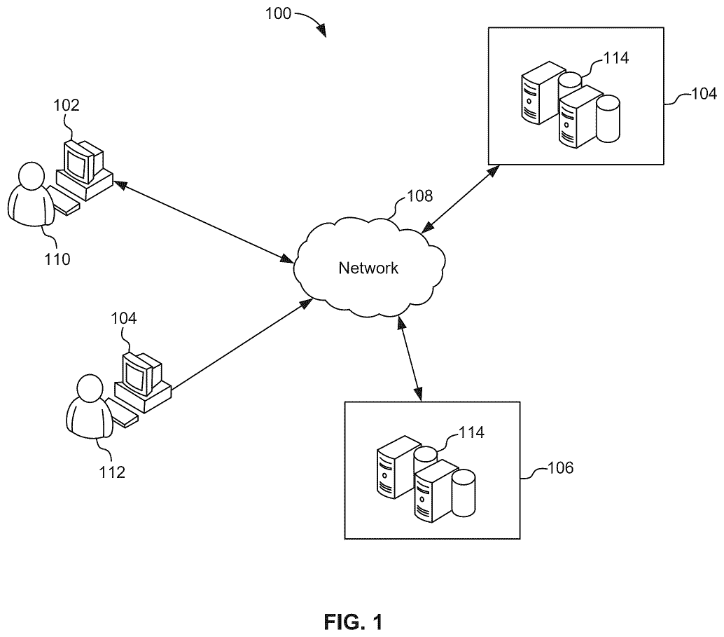

FIG. 1 depicts an example environment 100 that may be used to execute implementations of the present disclosure. In some examples, the example environment 100 enables configuration of software packages to perform one or more tasks.

As depicted in FIG. 1, the example environment 100 includes computing devices 102 and 104, back-end systems 106, and a network 108. In some examples, the computing devices 102 and 104 are used by respective users 110 and 112 to log into and interact with computing platforms executing applications according to implementations of the present disclosure. Examples of the computing devices 102 and 104 may include desktop computing devices, smartphones, laptops, tablet, voice-enabled devices, and/or the like. It is contemplated that implementations of the present disclosure may be realized with any appropriate type of computing device. In some examples, each of the computing devices 102 and 104 may include a web browser application executed thereon, which may be used to display one or more web pages of a computing platform executing applications. In some examples, each of the computing devices 102 and 104 may display one or more Graphical User Interfaces (GUIs) that enable the respective users 110 and 112 to interact with the computing platform.

In some examples, the network 108 includes a Local Area Network (LAN), a Wide Arca Network (WAN), the Internet, or a combination thereof, and connects web sites, the computing devices 102 and 104, and the back-end systems 106. In some examples, the network 108 may be accessed over a wired and/or a wireless communication link. For example, a computing device like smartphone may utilize a cellular network to access the network 108.

In some examples, one or more of the back-end systems 106 may be implemented as an on-premises system that is operated by an enterprise or a third-party engaged in cross-platform interactions and data management. In some examples, the back-end systems 106 may be implemented as an off-premises system (for example: cloud or on-demand) that is operated by an enterprise or a third-party on behalf of an enterprise. In some examples, one or more of the back-end systems 106 may be implemented in a cloud environment. For simplicity, the back-end systems 106 depicted in FIG. 1 may be a cloud environment that is intended to represent various forms of servers including a web server, an application server, a proxy server, a network server, a server pool, and/or the like.

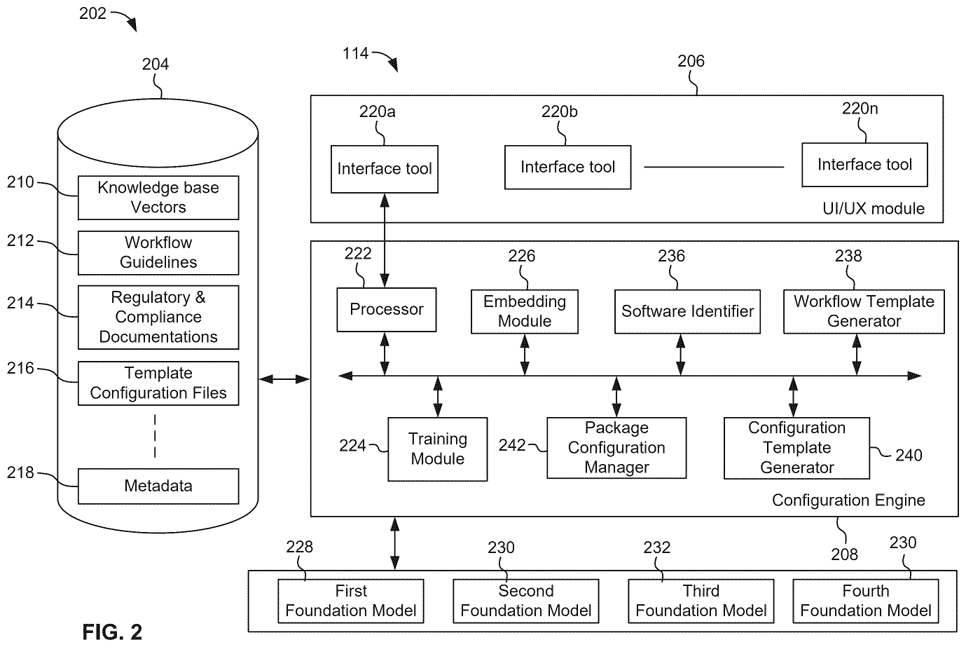

In some examples, each of the back-end systems 106 includes one or more configuration system 114 to host components (for example, software packages) of enterprise systems and applications. Further, the configuration system 114 accepts requests from the users 110 and 112 through the respective computing devices 102 and 104 for services being provided by the enterprise systems and the applications. In response to the accepted requests, the configuration system 114 provides the requested services to the computing devices 102 and 104 over the network 108. The requests received from the users 110 and 112 through the respective computing devices 102 and 104 may be conversational queries. The configuration system 114 may enable interactions between the one or more foundation models (as depicted in FIG. 2) and the users 110 and 112 to generate responses for the conversational queries. The interaction between the configuration system 114 and users 110, 112 may be conversational in nature, including conversational queries as well as conversational responses to the queries.

According to implementations of the present disclosure, the configuration system 114 may be adapted for configuring software packages for one or more tasks pertaining to the enterprises, in response to the conversational queries and the conversational responses. Numerous examples depicting the generation of configuration templates, and thereby configuring the software packages are described in detail in conjunctions with figures below.

FIG. 2 depicts an example architecture 202 of a configuration system 114 for generating configuration templates and configuring software packages using the configuration templates in accordance with implementations of the present disclosure. In an example, as depicted in FIG. 2, the configuration system 114 receives conversational queries and generates content/responses such as, but are not limited to, text, images, audio, video, and/or the like, for the conversational queries. The conversational queries may include prompts for configuring one or more software packages. The conversational responses may include additional information, feedback/inputs, and/or the like required for configuring the one or more software packages.

The configuration system 114 includes a knowledge base 204, a User Interface (UI)/User Experience (UX) module 206, and a configuration engine 208. The knowledge base 204 may be described as a structured repository or database associated with the configuration system 114. The knowledge base 204 may incorporate various knowledge representation schemes, such as ontologies, taxonomies, or semantic networks, to encode and organize information in a machine-understandable format, thereby enabling advanced search, inference, and reasoning capabilities. Furthermore, the knowledge base 204 may leverage advanced technologies, including natural language processing, machine learning, and knowledge engineering techniques, to enhance knowledge acquisition, update, and refinement processes, ensuring its continual relevance and adaptability to evolving needs and circumstances.

In some implementations, the knowledge base 204 includes knowledge base vectors 210, workflow guidelines 212, regulatory and compliance documentations 214, template configuration files 216, metadata 218, and additional information (not shown) pertaining to the configuration system 114. The knowledge base vectors 210 may be described as knowledge data being stored in form of vector representations, which facilitate efficient retrieval and utilization. The knowledge data may include structured information that encompasses data, facts, and insights derived from various data sources. Such structured information may be organized in a coherent manner to support decision-making, problem-solving, and system operations within the configuration system 114. The workflow guidelines 212 may be described as guidelines pertaining to sequential steps and decision-making processes involved in generating the configuration templates.

The regulatory and compliance documentations 214 may be described as documentations detailing legal and industry standards relevant to configuration of the software packages. The regulatory and compliance documentations 214 may ensure that the configured software packages adhere to regulatory mandates and industry best practices, while minimizing legal risks for the enterprise. The template configuration files 216 may be described as files containing predefined configurations and parameters for generating the configuration templates. The metadata 218 may be described as descriptive information pertaining to the data including, workflow guidelines 212, regulatory and compliance documentations 214, and template configuration files 216 stored within the knowledge base 204.

The UI/UX module 206 may be defined as a module, which designs and manages a user interface (UI), via which the user interacts with the configuration system 114, and the user's experience (UX) during said interaction. The UI/UX module 206 may integrate various technologies and frameworks to optimize visual layout, interactive elements, and overall usability, often utilizing principles of human-computer interaction (HCI) and graphic design.

In some examples, the UI/UX module 206 may represent one or more front-end components/interfaces 220a-220n of a chatbot that may be executed on one or more of the computing devices 102 and 104 to enable receipt of the conversational queries and providing one or more response to the conversational queries. In some examples, the conversational query may be received through various modalities including, but not limited to, a question input to a chat bot, a request provided through a Graphical User Interface (GUI), an email, and/or the like.

The configuration engine 208 may be configured for processing the conversational queries received through the UI/UX module 206 using foundation models 228-234. Each of the foundation models 228-234 may be described as a general-purpose Generative Artificial Intelligence (GAI) model like large deep learning neural network. The large deep learning neural network may be trained using broad range of generalized, unlabeled training data and that may perform a multitude of general tasks. Examples of the tasks may include generating text, generating images, conversing in natural language, generating video, generating audio, and/or the like. In some examples, the applications may be built on top of the foundation models 228-234. In some examples, multiple foundation models 228-234 may be used to perform a range of functionality for an application.

The foundation models 228-234 may include, for example, Large Language Models (LLMs), which are a form of GAI that may be used to generate text for a variety of use cases. In some examples, the LLMs may be integrated in digital assistants (for example: chatbots), replacing traditional rule-based systems to provide textual responses to a user input. A LLM may be described as an advanced type of language model that is trained using deep learning techniques on massive amounts of text data. The text data is general and not specific to any particular domain. A LLM may described as an advanced type of language model that is trained using deep learning techniques on massive amounts of text data. The text data is general and not specific to any particular domain. The LLMs may generate human-like text and perform various Natural Language Processing (NLP) tasks (for example, translation, question-answering, and/or the like). In some examples, the LLM refers to models that use deep learning techniques and have a plurality of parameters, which may range from millions to billions. The LLMs may capture complex patterns in language and produce text that is often indistinguishable from that written by humans. The produced text may be processed through a deep learning architecture such as, recurrent neural network (RNN), a transformer model, and/or the like.

While implementations of the present disclosure are described in further detail herein with non-limiting reference to the LLMs as the example foundation models 228-234, it is contemplated that implementations of the present disclosure may be realized using any appropriate foundation models or Machine Learning (ML) models, or Artificial Intelligence (AI) models. Such models may generate the content/response based on any appropriate modality (for example, text, audio, image, video, and/or the like). In some examples, the response may correspond to the one or more tasks being represented by the conversational queries.

The foundation models 228-234 are configured to be communicatively coupled. In this way, the foundation models 228-234 utilize a two-way connection, where each of the foundation models 228-234 generate a response (i.e., output) which is consumed by a subsequent foundation model, which, in-turn provides feedback to a previous foundation model. Additionally, each of the foundation models 228-234 may be incorporated with a reinforcement learning (RL) framework, which enables the foundation models 228-234 to dynamically update and learn from the feedback received from the previous foundation model.

In some examples, the foundation models 228-234 may be provided by one or more third parties. In some examples, the foundation models 228-234 may be provided by one or more enterprises deployed the configuration system 114. The foundation model receives requests/queries and provide responses to the queries. For example, requests/queries may be received as conversational queries through an Application Programming Interface (API).

The configuration engine 208 includes one or more processors 222, a training module 224, an embedding module 226, a software identifier 236, a workflow template generator 238, a configuration template generator 240, and a package configuration manager 242.

The processor 222 may include, for example, microprocessors, microcomputers, microcontrollers, digital signal processors, central processing units, state machines, logic circuits, and/or any devices that manipulate data or signals based on operational instructions. Among other capabilities, the processor 222 may fetch and execute computer-readable instructions in a memory operationally coupled with the configuration system 114 for generating the configuration templates. Any reference to a task in the present disclosure may refer to an operation to be performed after the software packages are configured. In some instances, the software packages are configured by deploying the generated configuration templates for performing the task.

The training module 224 trains the foundation models 228-234 for performing intended functions as described in the present disclosure. The training module 224 may utilize historical data pertaining to configuration of software packages for training the foundation models 228-234. Further, the training module 224 may utilize one or more training techniques, including but not limited to, a gradient descent technique, a stochastic gradient descent technique, a batch gradient descent technique, a backpropagation technique, a dropout technique, a data augmentation technique, an early stopping technique, and a learning rate scheduling technique for training the foundation models 228-234.

The embedding module 226 transforms the conversational queries and the conversational responses (also be referred to as high-dimensional input data), such as words or tokens from text corpora, into lower-dimensional vector representations known as embeddings. These embeddings encode semantic information about the input data, facilitating the capture of relationships and similarities between words or tokens. The embedding module 226 employs various techniques, including Word Embeddings (such as Word2Vec, GloVe) and contextual embeddings (like ELMo, BERT) for generating dense numerical representations of words based on their contextual usage. These embeddings serve as compact and informative representations suitable for downstream machine learning tasks, such as text classification, sentiment analysis, and language modeling.

In some instances, the embedding module 226 may be implemented with respect to Retrieval-Augmented Generation (RAG). Within the RAG framework, the embedding module 226 is utilized in both the retrieval and generation processes. The embedding module 226 may advantageously enable efficient information retrieval by representing the conversational queries and retrieved documents, while also guiding the generation of coherent responses by encoding contextual information.

It should be noted that the conversational queries and the conversational responses represented in the vector forms are used to generate the configuration templates for configuring the software packages.

Upon generating the vector forms/representations of the conversational queries/responses, the software identifier 236 uses the first foundation model 228 to identify a set of software packages to be configured for performing one or more tasks. Examples of the tasks may include automating Human Resource (HR) tasks, automating Information Technology (IT) related tickets, project management, dealer management, and/or the like. The set of software packages may be identified based on evaluation of the conversational queries. For example, if a user wants to configure onboarding process, evaluation process, feedback process, then the processor 222 may identify the set of software packages pertaining to a HR tool for configuration.

For identifying the set of software packages, the software identifier 236 may determine a task context and task intent from the conversational queries and the conversational responses using the first foundation model 228. The task context may be described as encompassing conditions, circumstances, and background information surrounding a task or query, which provides essential contextual cues that influence the interpretation and execution of the task within a given environment or domain. The task intent may be described as underlying purpose or objective behind the task or query, which encapsulates the desired outcome or action to be achieved through execution of the task that is determined by the user's intentions or goals.

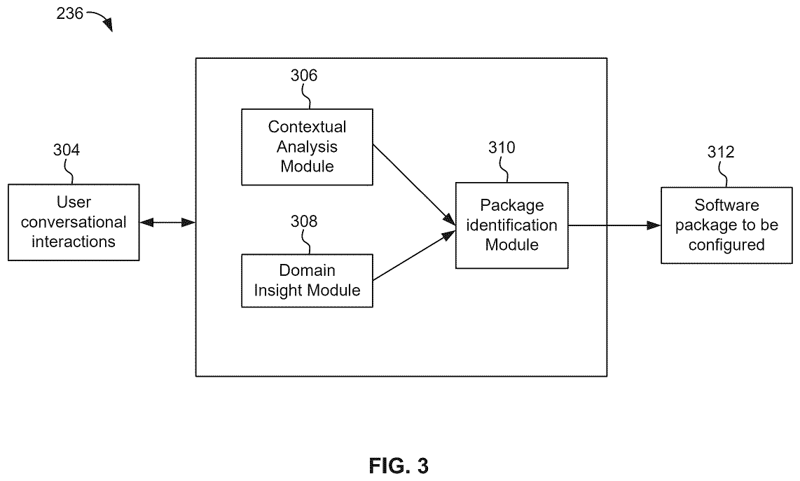

Further, the software identifier 236 uses the first foundation model 228 to perform contextual and domain analysis on the identified task context and the task intent and to identify the set of software packages to be configured. The contextual and domain analysis involves analyzing the identified task context and intent with respect to historical data, identifying semantic data from the historical data matching with the identified task context and intent, and identifying the software packages associated with the semantic data for configuration. For example, if the context of a task pertains to automating HR functions, the historical data/knowledge pertaining to a HR domain may be used to identify the software packages for configuration. Advantageously, the contextual and domain analysis filters a search performed on the historical data, while increasing accuracy and efficiency. Identifying the software packages for configuration using the first foundation model 228 is explained in detail along with FIG. 3.

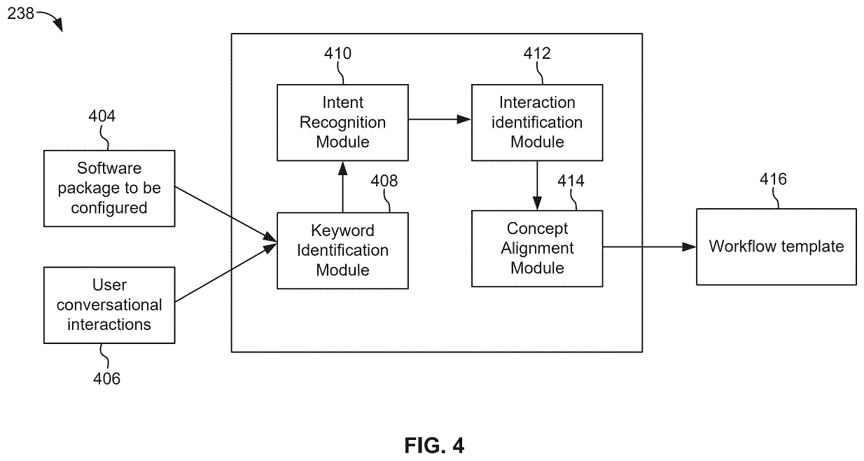

Upon identifying the software package for configuration, the workflow template generator 238 uses the second foundation model 230 to generate a workflow template for configuring the identified software packages. The workflow template may be generated based on the task context, task intent, and the conversational responses. The workflow template may include a high-level workflow to be utilized for configuring the software package. In some instances, a unique workflow template may be generated for each software package to be configured. The workflow template may indicate one or more processes to be configured, configuration details for processing such processes, and/or the like. In some examples, the processes may indicate one or more steps/actions to be performed to accomplish the tasks associated with the set of software packages. The processes may vary depending on the tasks to be performed and the associated set of software packages. For example, if the software package identified to be configured is intended for performing HR related tasks, then the processes may include onboarding processes, performance and setting processes, and feedback related processes. Generating the workflow template using the second foundation model 230 is explained in detail along with FIG. 4.

The configuration template generator 240 uses the third foundation model 232 to refine configuration fields of the workflow template for subtasks of each task based on the conversational responses. The configuration fields may refer to fields of the processes identified in the workflow template. For example, if the subtask is related to ‘Employee Job’, pertaining to an enterprise's HR portal, a configuration field ‘Employee Job’ may be refined as ‘Business Unit’.

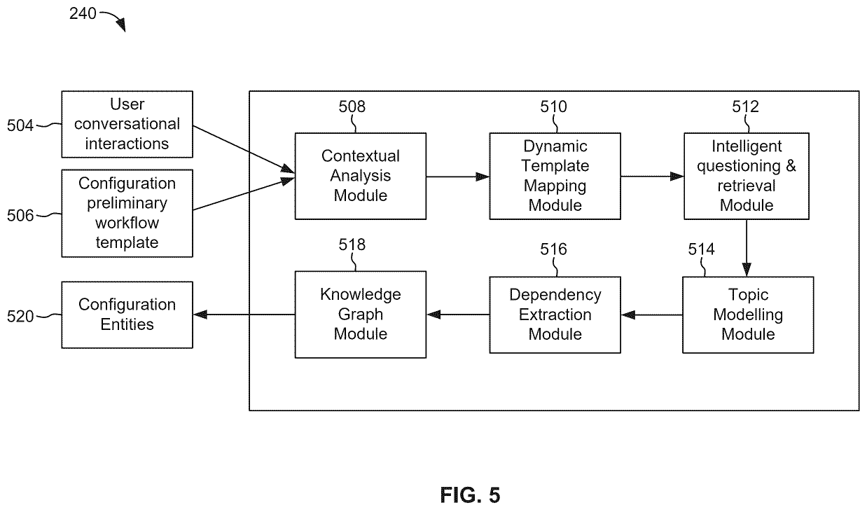

The third foundation model 232 may be trained by the training module 224 to have a deep understanding of the task and the task intent, the configuration fields of the workflow template for the subtasks of each task, and the like. Utilizing this understanding, the third foundation model 232 may be used to encode complex dependencies based on relationships between the tasks and subtasks, historical intents, task context and domain, the configuration fields of the workflow template, and the like via the embedding module 226. In some instances, the dependencies may be encoded onto a graph neural network. Advantageously, encoding the dependencies onto the graph neural network enables quick, efficient, and accurate analysis of the workflow template and refines the configuration fields of the workflow template using the third foundation model 232, which is explained in detail along with FIG. 5.

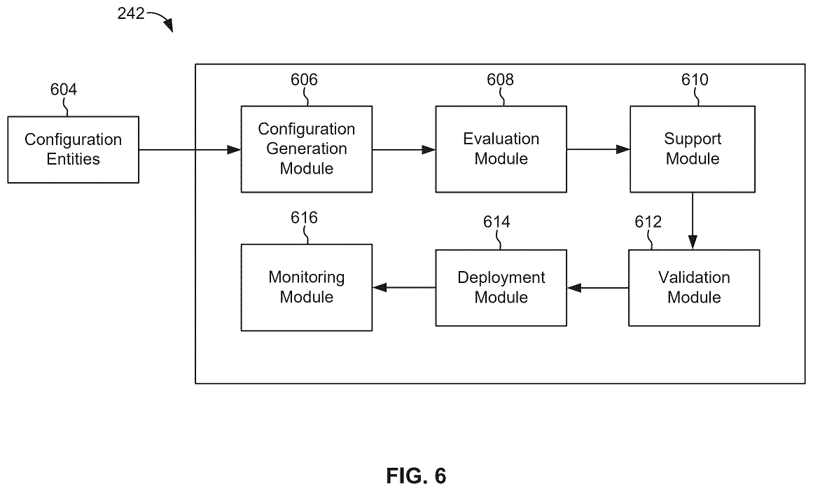

The package configuration manager 242 uses the fourth foundation model 234 to generate configuration fields of the configuration templates for each task based on the configuration fields of the work templates associated with the subtasks and the conversational responses. The configuration templates may include the workflow template with the refined configuration fields. The generated entities by the package configuration manager 242 may pertain to fields of the configuration templates. The package configuration manager 242 uses the fourth foundation model 234 to generate the configuration fields of the configuration templates by collaborating and combining the configuration fields of the workflow templates refined using the third foundation model 232. Additionally, the fourth foundation model 234 may be used to check for errors while updating the configuration fields of the configuration template with actual instances, thereby increasing accuracy of the configuration templates. For example, the package configuration manager 242 may utilize the fourth foundation model 234 to identify if a parent field was ignored, a child field was added, and the like. In operation, the package configuration manager 242 uses the fourth foundation model 234 to combine individual configuration elements received from the configuration template generator 240, while ensuring that resulting configuration is cohesive and correct. Generating the configuration fields of the configuration templates using the fourth foundation model 234 is explained in detail along with FIG. 6.

The package configuration manager 242 also uses the fourth foundation model 234 to configure the software package on the computing device 102-104 associated with the user 110-112, based on the configuration templates generated for the task.

FIG. 3 is a block diagram that presents an example of the software identifier 236 including components for identifying the software packages to be configured using the first foundation model 228 in accordance with implementations of the present disclosure. The software identifier 236 may also be referred to as a context identifier agent (CIA).

The software identifier 236 may receive the user conversational interactions 304 and use the first foundation model 228 to identify the set of software packages to be configured 312 based on the user conversational interactions 304. The user conversational interactions 304 may include the conversational queries, as well as responses to the conversational queries (i.e., conversational responses). In some instances, the user conversational interactions 304 may be provided as prompts and respective responses. The conversational queries may request the first foundation model 228 to perform an intended action associated with the present disclosure.

The software identifier 236 includes a contextual analysis module 306, a domain insight module 308, and a package identification module 310.

The contextual analysis module 306 analyses a context of the conversational query from the user conversational interactions 304. Advantageously, the contextual analysis module 306 enables nuanced understanding and appropriate responses based on the user conversational interactions 304.

The domain insight module 308 garners insights pertaining to a domain of the conversational query from the user conversational interactions 304. The domain may refer to a distinct and defined field of knowledge, expertise, or activity characterized by specific principles, rules, and methodologies. Advantageously, the domain may delineate the boundaries within which specialized knowledge is developed, applied, and refined. Examples of the domain may include a financial domain, a human resources domain, an information technology domain, a supply chain domain, a marketing domain, a legal and compliance domain, and the like. Additionally, the insights may refer to discernible and valuable interpretations or understandings derived from data analysis, research, or observation, providing deeper understanding or foresight into a particular subject or situation. Examples of the insights may include customer behavior analysis, market trends, operational performance metrics, scientific research findings, strategic business intelligence, and the like. In some instances, when the domain is not clear from the user conversational interactions 304, the software identifier 236 may request the user to provide some information about the domain.

The context and domain insights analyzed by the contextual analysis module 306 and the domain insight module 308, respectively, are inputted into the package identification module 310. The package identification module 310 identifies software packages to be configured 312, based on the context and domain insights.

In some instances, the package identification module 310 may utilize prompt engineering, along with the context and domain insights, to identify the software packages that need to be configured. For example, the package identification module 310 may generate a prompt for the first foundation model 228 based on the context and domain insights. The package identification module 310 submits the prompt to the first foundation model 228 and receives an output from the first foundation model 228. The output received from the first foundation model 228 indicates the software packages to be configured.

The first foundation model 228 may be further retrained based on whether the software packages identified to be configured using the first foundation model 228 is correct or not. In an example, the first foundation model 228 may be retrained by observing the user's interactions with a subject matter expert (SME). Additionally, the first foundation model 228 may be retrained utilizing feedback of the second foundation model 230 on identification of appropriate software packages to enhance learning of the first foundation model 228 and increase accuracy in correctly identifying the software packages. Identification of the appropriate software packages to be configured reduces costs and computational time involvement, while increasing efficiency and accuracy of the system.

For example, consider a conversational interaction received by the software identifier/CIA 236 discusses about onboarding process, performance evaluation procedures with more engaging evaluations using continuous and 360-degree feedback. In such a scenario, the software identifier 236 identifies software packages related to process onboarding, performance evaluation, and job information processes for configuration.

FIG. 4 is a block diagram 400 that presents an example of the workflow template generator 238 including components for generating the workflow template using the second foundation model 230 in accordance with implementations of the present disclosure. In some instances, the second foundation model 230 may be referred to as a task workflow agent.

The workflow template generator 238 may generate the workflow template 416 based on the software packages to be configured 404 and the user conversational interactions 406/304. The workflow template generator 238 includes a keyword identification module 408, an intent recognition module 410, an interaction identification module 412, and a concept alignment module 414.

The keyword identification module 408 identifies keywords from the user conversational interactions 406/304. Further, the keyword identification module 408 may be communicably coupled to a data repository containing historical data pertaining to keywords and their understanding. The keyword identification module 408 may identify relevant keywords by mapping random words from the user conversational interactions 406/304 with the historical data. For example, the keyword ‘role’ may pertain to a role of the user. Advantageously, identification of relevant keywords by the keyword identification module 408 enable accurate intent recognition.

The intent recognition module 410 recognizes an intent of the user based on the user conversational interaction 406/304, as well as the keywords identified by the keyword identification module 408. The intent refers to an underlying objective or purpose inferred from user input, encapsulating the desired action or outcome to be achieved within a defined computational framework. The intent recognition module 410 may be coupled to a data repository containing historical data pertaining to intents and inherent intents. Further, the intent recognition module 410 may identify the intent from identified keywords by mapping the keywords with the historical data pertaining to intents. For example, the intent may be to configure an enterprise HR portal with an enterprise project assignment portal. Advantageously, recognition of appropriate intent enables accurate generation of workflow templates.

In some instances, the user may converse in a non-standard language about specific processes. In such instances, the intent recognition module 410 is paramount to identifying the intent/context from user interactions. For example, a user may often be unaware regarding exact names of different entities while configuring a software, like a human resources employee utilizing a human resources (HR) tool may not know an exact process name for configuring the software. In these cases, the intent recognition module 410 may identify the user's intent based on user inputs. If the user asks to configure the ‘Job Information’ process, the intent recognition module 410 may identify the intent behind the user's request, and map this to an ‘EmpJob’ process in the HR tool. Advantageously, the intent recognition module 410 accurately and efficiently understands user intent, reducing reliance on subject matter experts, which eventually substantially reduces time taken to configure the software.

The interaction identification module 412 leverages the user conversational interactions 406 to identify configuration requirements for the software packages. The interaction identification module 412 utilizes the user conversational interactions 406, the software packages to be configured 404, along with the intent recognized by the intent recognition module 410 for identifying the configuration requirements. The configuration requirements may pertain to a type of configuration, a duration of configuration, a typical style for configuration, and the like, which are individualized for each software package to be configured.

Additionally, the interaction identification module 412 may identify ‘gaps’ in the identified configuration requirements and supplement the configuration requirements by extracting relevant information from the user during the user conversational interactions 406. For example, if the interaction identification module 412 identifies that details pertaining to the HR portal to be configured are not available, the interaction identification module 412 requests the user/SME to provide the details while initiating an interaction with the user/SME.

The concept alignment module 414 aligns known concepts with configuration requirements provided by the interaction identification module 412. Concept alignment refers to aligning different conceptual frameworks, models, or representations within a system or domain to ensure consistency and compatibility. Since different components may have distinct functions, often the disparate nature results in operational difficulties. In order to mitigate this, the concept alignment module 414 maps the configuration requirements for each software package with the historical data to identify potential threats. The concept alignment module 414 maps the configuration requirements for each software package using one or more of: keywords, intent, context, standard embedding similarity techniques, and/or the like. For example, the concept alignment module 414 may encode and identify similar concepts in an HR portal and a talent management portal. Advantageously, the concept alignment module 414 harmonizes definitions, semantics, and structures to facilitate accurate communication, interoperability, and understanding among components involved in the domain or system.

Thereafter, the concept alignment module 414 resolves the potential threats to align the configuration requirements to generate a workflow template 416 for each software package to be configured. The workflow template 416 may be described as a high-level workflow detailing a plan for configuring the software package. In an example, if the software packages to be configured pertain to a performance portal, the workflow template 416 may include a performance appraisals process having performance evaluation forms, definitions, or requirements for set ratings, bonus percentage table based on evaluation, information pertaining to the review cycles, and the like. In another example, if the software packages to be configured pertain to an employee portal, the workflow template 416 may include an onboarding process, an offboarding process, a leave process, and the like. Here, each such process may have information pertaining to definitions and/or requirements, including forms, rules, and regulations, and the like.

In some instances, the workflow template generator 238 may observe SME actions during user-SME interactions and utilizes the observed SME actions to predict a next action. In such instances, an actual action taken by the SME may be considered as feedback to the next action predicted by the workflow template generator 238. The actions may pertain to the configuration fields of the workflow template 416.

Additionally, other techniques and information in addition to the above-mentioned may enable the workflow template generator 238 to generate the workflow template 416 in an efficient and accurate manner by providing additional information. An example of such additional information may be metadata, template configurations, or a retrieval augmented graph. Further, the workflow template generator 238 may implement the second foundation model 230 as a standard conversational foundation model which is specifically trained to generate the workflow templates 416.

FIG. 5 is a block diagram 500 that presents an example of the configuration template generator 240 including components for refining configuration templates of the workflow template using the third foundation model 232 in accordance with implementations of the present disclosure. In some instances, the configuration template generator 240 may be referred to as a task expert agent. The configuration template generator 240 may receive the user conversational interactions 504/304/406 and the workflow templates 506 and refine the configuration fields of the workflow template using the third foundation model 232.

The configuration template generator 240 may include a contextual analysis module 508, a dynamic template mapping module 510, an intelligent questioning and retrieval module 512, a topic modelling module 514, a dependency extraction module 516, and a knowledge graph module 518.

The contextual analysis module 508/306 analyses the context from the user conversational interactions 504 and the workflow templates 506. The context analyzed by the contextual analysis module 508 may be referred to as a new context. It will be appreciated that since accuracy is paramount for solutions presented in the present disclosure, the context may get analyzed at multiple stages to ensure correctness. In operation, the contextual analysis module 508 verifies the user conversational interactions 504 to ensure that context has been analyzed correctly previously by mapping the new context with the workflow templates 506. In case the context was not correctly identified previously, the contextual analysis module 508 performs appropriate corrections to the workflow template to update the workflow template based on the new context.

The dynamic template mapping module 510 dynamically maps the workflow template with typical configuration template requirements based on the user interaction, inputs from other modules, as well as historical data. The dynamic template mapping module 510 may be communicably coupled with a data repository containing historical data pertaining to software configurations, software packages, configuration fields of workflow templates, and configuration requirements. In this regard, the dynamic template mapping module 510 may identify missing information which is essential for configuring the software packages by accessing the data repository. For example, if historical data indicates that the configuration fields pertaining to options on the HR portal are essential for configuring the HR portal, the dynamic template mapping module 510 may identify that information pertaining to the options on the HR portal is missing and relays this information to the intelligent questioning and retrieval module 512.

The intelligent questioning and retrieval module 512 interacts with the user to extract relevant information via intelligent questions presented to the user. Utilizing the missing information shared by the dynamic template mapping module 510 and leveraging the historical data from the data repository, the intelligent questioning and retrieval module 512 frames intelligent questions to extract the missing information from the user. In some instances, the intelligent questioning and retrieval module 512 attempts to extract all missing information in the one or more conversational interactions initiated with the user. It will be appreciated that the intelligent questioning and retrieval module 512 may interact with the user via the UI/UX module 206. Thereafter, the intelligent questioning and retrieval module 512 shares user responses to said intelligent questions with the topic modelling module 514 to refine the workflow template.

The topic modelling module 514 iteratively refines the configuration fields of the workflow template. The topic modelling module 514 may rank the configuration fields of the workflow template according to a reward function, update the workflow template according to the rankings of the associated configuration fields, and sample the workflow template from a ranking value distribution.

The reward function quantifies success or desirability of actions proposed in (i.e., the configurations fields) the workflow template based on the achieved outcomes. The reward function assigns a numerical value or score to different configuration fields proposed in the workflow template, iteratively revising the configuration fields to ensure maximize cumulative rewards over time. For example, the reward function may be assigned by way of non-limiting example, using RL that is known in the art and not further described herein.

The dependency extraction module 516 identifies complex dependencies between processes, fields, industry, domain, client, and intent for configuring software packages. The dependency extraction module 516 may be communicably coupled to the data repository and may utilize the data repository to map different dependencies using a neural network. For example, a leave module in the HR portal may be dependent upon an attendance module in the HR portal. Advantageously, identification of dependencies amongst various elements enables faster, efficient, and reliable identification of the configuration fields 520.

The knowledge graph module 518 encodes dependencies identified by the dependency extraction module 516 into the neural network. The neural network may be implemented as one or more of a graph neural network, a knowledge graph, and/or the like. In such a neural network, elements are represented as nodes and edges. The nodes represent configuration fields/options to be configured with respect to the identified software package for configuration, concepts, process, and the like, and the edges represent relationships between the different nodular elements. The knowledge graph module 518 may utilize suitable graph learning techniques to encode and retrieve information, as well as trivial and complex dependencies in graphical formats efficiently and intelligently.

The graph learning techniques refer to techniques which learn dependency structures, (the graph itself), as well as dependency strengths within the graph (values of dependencies between graph nodes) by leveraging training data. In operation, the graph learning techniques accurately and inherently ‘know’ the graph. Some graph learning techniques may also be flexible, inculcating subject matter expert inputs to modify a learnt graph structure manually. Advantageously, the graph learning techniques extract exact dependencies and strengths between attributes, leading to increased accuracy. Examples of the graph learning techniques may include probabilistic graphical models (PGM), graph neural networks, graph embedding models, and the like.

Further, based on the encoded dependencies, the configuration fields 520 of the workflow template may be refined. For example, the configuration fields 520 of the workflow template may be implemented as an employee serial number, an employee name, an employee home address, an employee blood group, an employee health information, and the like. It will be appreciated that each workflow template may comprise a plurality of configuration fields 520, which are individually configured for configuring the software package.

FIG. 6 is a block diagram 600 that presents an example of the package configuration manager 242 including components for generating the configuration fields of the configuration template for the tasks and configuring the software packages using the fourth foundation model 234 in accordance with implementations of the present disclosure. In some instances, the package configuration manager 242 may be referred to as a task expert agent. The package configuration manager 242 may receive the refined configuration fields of the workflow template from the configuration template generator 240 and use the refined configuration fields to generate the configuration template, deploy/configure the software package using the configuration template, and monitor configuration of the software package.

The package configuration manager 242 includes a configuration generation module 606, an evaluation module 608, a support module 610, a validation module 612, a deployment module 614, and a monitoring module 616.

The configuration generation module 606 may generate configuration functions based on the refined configuration fields 604/520 of the workflow template. The configuration functions may be defined as computer-executable instructions pertaining to configuration of a software package, which, on execution, generate the configuration fields of the configuration template. The configuration generation module 606 may be communicably coupled to the data repository containing historical data pertaining to software configurations, software packages, software package entities, and configuration requirements. In this way, the configuration generation module 606 may leverage the historical data to map the refined configuration entities of the workflow template to generate the configuration functions.

Additionally, the configuration generation module 606 collaborates and combines the configuration functions to support the validation module 612 in generating the configuration template. In this way, the configuration generation module 606 may identify discrepancies and errors in the configuration functions, for improving the functions of the fourth foundation model 602/234.

The evaluation module 608 evaluates each configuration function to ensure correctness. The evaluation module 608 may systematically verify functionality and integrity of the configuration functions, ensuring that configured elements meet predefined criteria and standards, thereby validating the accuracy and reliability of the configuration process. In some instances, the evaluation module 608 may leverage historical data to evaluate and rank each configuration function, such that configuration functions ranked below a pre-defined threshold are reiterated to the configuration generation module 606 for re-generation.

The support module 610 provides ongoing support to issues identifies by any of the other modules of the package configuration manager 242. Additionally, the support module 610 make necessary adjustments to individual outputs of the other modules for completeness. In operation, the support module 610 supports functions of the package configuration manager 242, ensuring smooth interaction between the other modules.

In some instances, the support module 610 may provide a simulation of the configured software package to the user. In such instances, the support module 610 may garner user inputs on changes required to the configuration functions for appropriate deployment of the configured software packages.

The validation module 612 generates a configuration template for configuring the software packages. In such, the validation module 612 may validate each configuration function for correctness before generating the configuration template. The configuration template is generated based on the configuration functions, along with inputs from the support module 610. The inputs from the support module 610 pertain to addressal of issues discovered by the validation module 612.

The deployment module 614 implements and executes the configuration templates. The deployment module 614 utilizes the configuration template for deploying configured software packages. It will be appreciated that the deployment module 614 facilitates automated deployment of configured software packages, ensuring that specified settings, parameters, and functionalities are effectively applied and integrated into an operational environment, thereby enabling efficient and standardized deployment processes.

The monitoring module 616 may refer to a module which monitors the software packages to ensure appropriate functionality. Further, the monitoring module 616 may identify when a software package is not functioning appropriately, halt functioning of the software package, and re-configure the software package by utilizing the foundation models 228-234.

In some instances, the package configuration manager 242 may collaborate and combine configuration information from the refined configuration fields 604 of the workflow template to generate the configuration templates. Since the package configuration manager 242 does not directly utilize user-SME interactions, the package configuration manager 242 may identify discrepancies in the configuration fields 604 of the workflow template and provides the same as feedback to the configuration template generator 240 for rectification.

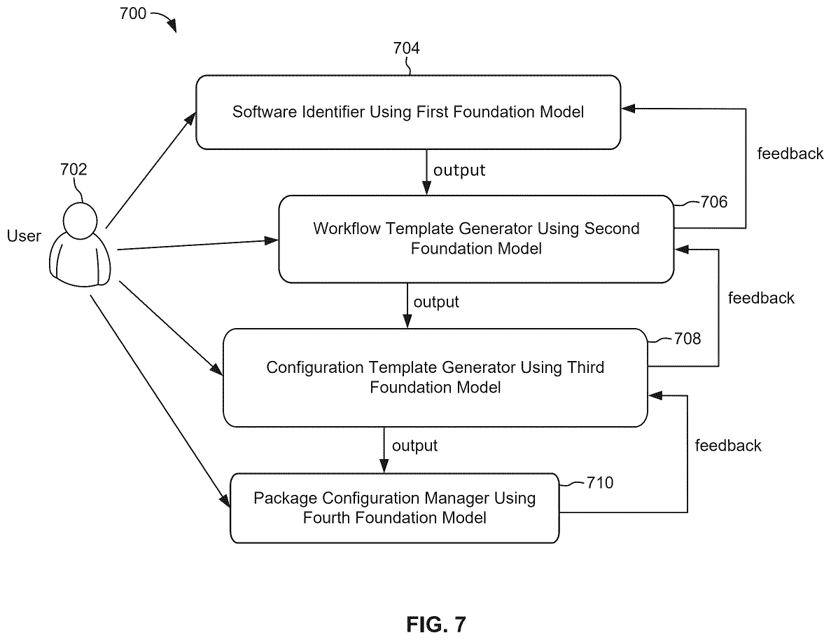

FIG. 7 depicts an example illustration 700 of configuring software packages in accordance with implementations of the present disclosure. As shown, the user 702/110-112 may freely interact with each of the foundation models 704, 706, 708, and 710/228-234 through the respective software identifier 236, the workflow template generator 238, the configuration template generator 240, and the package configuration manager 242. The first foundation model 704/228, the second foundation model 706/230, the third foundation model 708/232, and the fourth foundation model 710/602/234 have been described in detail with respect to FIGS. 3, 4, 5, and 6, respectively. A collaborative nature of the foundation models 704-710 implemented in the present disclosure is depicted in FIG. 7, where the foundation models 704, 706, 708, and 710 work in tandem to configure the software packages. As shown in FIG. 7, output of each component of the system 114 using the foundation model may be shared with a succeeding component using another foundation model, and feedback with a preceding component.

The software identifier 236 uses the first foundation model 704/228 to identify the software packages that the user wishes to be configured and share the software packages to be configured as output to the workflow template generator 238. Thereafter, the workflow template generator 238 uses the second foundation model 706/230 to provide feedback to the first foundation model 704/228 pertaining to the software packages to be configured. In case any changes are required based on the feedback, the first foundation model 704/228 may be used to implement the changes and share revised software packages to be configured to the workflow template generator 238 using the second foundation model 706/230.

The second foundation model 706/230, thereafter may be used to process the software packages to be configured by accessing the context and intent and creates the workflow templates. The workflow templates generated using the second foundation model 706/230 may be provided to the third foundation model 708/232 as output. The third foundation model 708/232 may be used to provide feedback on the workflow templates to the workflow template generator/second foundation model 706/230.

Thereafter, the third foundation model 708/232 may be used to ask relevant queries from the user, refine the workflow template, and extract and encode dependencies pertaining to the configuration fields of the workflow template via a neural network to generate the configuration templates. The third foundation model 708/232 provides the configuration templates to the package configuration manager 242/fourth foundation model 710/602/234 as output. The feedback on the configuration templates generated using the fourth foundation model 710 may be provided to the configuration template generator 240/the third foundation model 708/232.

Further, the fourth foundation model 710 may be used to generate the configuration templates and deploy the configuration templates to configure the software packages.

In an exemplary embodiment of the present disclosure, the software identifier 236 utilizes the first foundation model 228 to converse with the user. These conversations may be referred as the user conversational interactions 304/406/504. For example, the software identifier 236 utilizes the first foundation model 228/704 to identify that an HR process tool is to be configured from the user conversational interactions 304/406/504. The metadata associated with individual software tool packages may be utilized by the software identifier 236 to identify the set of software packages to be configured. The software identifier 236 may also confirm the set of software packages with the user and invite user inputs for mapping the set of software packages under a category.

Thereafter, the workflow template generator 238 utilizes the second foundation model 230/706 to generate the workflow template 416/506 based on the set of software packages to be configured. A configuration plan is generated for each entity (or, field) of the workflow template 416/506, by the configuration template generator 240 utilizing the third foundation model 232/708 to refine the configuration fields. The configuration fields may be refined by updating of the configuration fields 520/604 of the workflow template. The metadata is leveraged to utilize entity data to generate the configuration fields 520/604. The configuration template generator 240 also converses with the user to check if any optional entities (pertain to actions associated with the processes) are also required to be configured. If the optional entities need to be configured, the configuration template generator 240 generates/refines configuration fields for the optional entities as well.

Thereafter, the package configuration manager 242 utilizes the fourth foundation model 710 to generate and deploy the configuration template based on the generated configuration entities 520/604 and the user conversational interactions 304/406/504. The package configuration manager 242 may also utilize navigation properties and association sets from navigation properties to create option tags, extract parent-child relationships from the neural network/graph network to generate the configuration fields of the configuration network and tags; thereby utilizing the option tags, and the configuration fields to generate the configuration template/workflow. The configuration template may be saved and shared in an xml format to deploy the configuration template, thereby configuring the software package.

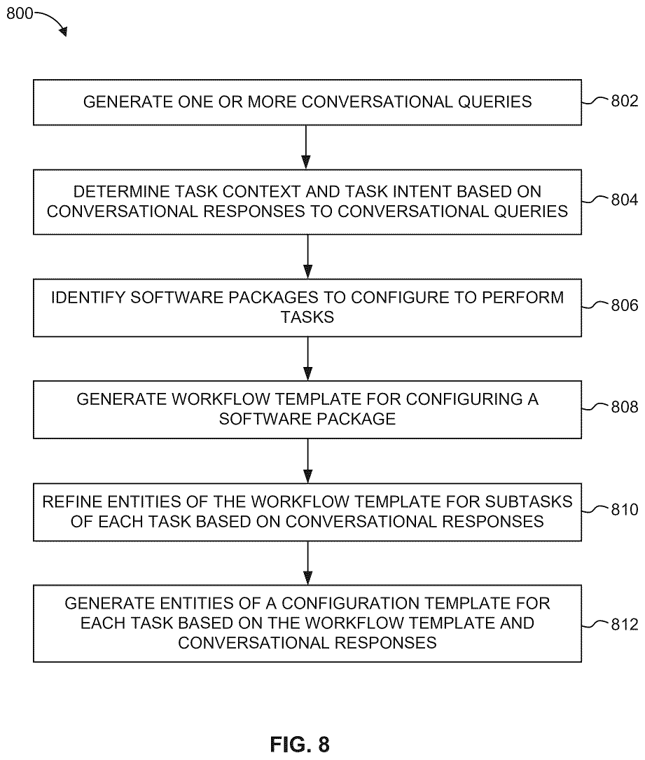

FIG. 8 is a flow diagram that presents an example method 800 for generating workflow templates in accordance with implementations of the present disclosure. In some implementations, the method 800 may be executed within the configuration system 114 as described in relation to FIG. 2.

At step 802, one or more conversational queries are generated. The conversational queries may be generated via a conversation between the configuration system 114 and the user. The conversational query may pertain to a query of the user extracted from the conversation.

At step 804, a task context and task intent are determined. The task context and task intent are determined based on conversational responses to the conversational queries. The task context and task intent may be determined by the software identifier 236 utilizing the first foundation model 228/704 with reference to FIG. 3.

At step 806, a set of software packages to be configured is identified. The set of software packages 312/404 may be identified based on the task context and task intent, as well as the user conversational interactions 304/406/504 with the user. The set of software packages 312/404 identified is to be configured to perform one or more tasks. The tasks are extracted by identifying user intent from the user conversational interactions 304/406/504. Based on the tasks to be performed, different sets of software packages 312/404 may be identified. The set of software packages 312/404 may be identified by the software identifier 236 utilizing the first foundation model 228/704 with reference to FIG. 3.

At step 808, the workflow template 416/506 is generated for configuring the software package from the set of software packages. Individual workflow templates may be generated for each software package to be configured. The workflow template 416/506 may be generated based on the task context, task intent, and the user conversational interactions 304/406/504. The workflow template 416/506 may be generated by the workflow template generator 238 utilizing the second foundation model 230/706 with reference to FIG. 4.

At step 810, the configuration fields of the workflow template 416/506 are refined for subtasks of each task. Each task may have several intricacies which are represented with respect to subtasks, with each subtask pertaining to a configuration requirement. The configuration fields of the workflow template 416/506 may be refined based on the user conversational interactions 304/406/504. The configuration fields may be refined by the configuration template generator 240 by utilizing the third foundation model 232/708 with reference to FIG. 5.

At step 812, the configuration fields of the configuration templates are generated for each task. The configuration fields of the configuration templates may be generated based on the refined configuration fields of the workflow templates and the user conversational interactions 304/406/504. Further, the configuration fields of the configuration templates may be generated by the package configuration manager 242 by utilizing the fourth foundation model 710/with reference to FIG. 6. Advantageously, the method 800 for generating workflow templates enables accurate, efficient, and reliable configuration of software packages, thereby saving significant cost and time involvements typically borne by the enterprises.

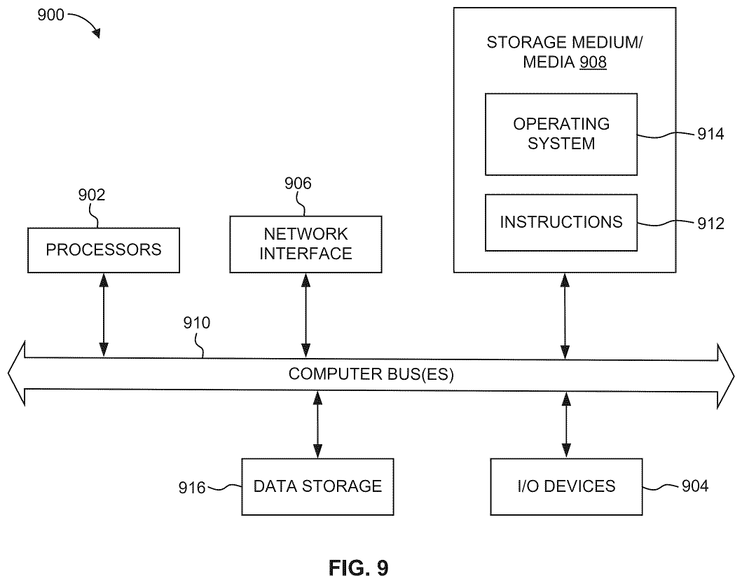

FIG. 9 illustrates a computer system 900 that may be used to implement the configuration system 114. More particularly, computing machines such as desktops, laptops, smartphones, tablets, and wearables which may be used to process the conversational interactions in the configuration system 114 may have the structure of the computer system 900. The computer system 900 may include additional components not shown and that some of the process components described may be removed and/or modified. In another example, a computer system 900 may be deployed on external-cloud platforms such as cloud, internal corporate cloud computing clusters, organizational computing resources, and/or the like.

The computer system 900 includes processor(s) 902, such as a central processing unit, ASIC or another type of processing circuit, input/output devices 904, such as a display, mouse keyboard, etc., a network interface 906, such as a Local Area Network (LAN), a wireless 802.11x LAN, a 3G or 4G mobile WAN or a WiMax WAN, and a processor-readable medium 908. Each of these components may be operatively coupled to a bus 910. The computer-readable medium 908 may be any suitable medium that participates in providing instructions to the processor(s) 902 for execution. For example, the computer-readable medium 908 may be non-transitory or non-volatile medium, such as a magnetic disk or solid-state non-volatile memory or volatile medium such as RAM. The instructions or modules stored on the computer-readable medium 908 may include machine-readable instructions 912 executed by the processor(s) 902 that cause the processor(s) 902 to perform the methods and functions of the configuration system 114.

The configuration system 114 may be implemented as software stored on a non-transitory processor-readable medium and executed by the processors 902. For example, the computer-readable medium 908 may store an operating system 914, such as MAC OS, MS WINDOWS, UNIX, or LINUX, and code for the configuration system 114. The operating system 914 may be multi-user, multiprocessing, multitasking, multithreading, real-time, and the like. For example, during runtime, the operating system 914 is running and the code for the configuration system 114 is executed by the processor(s) 902.

The computer system 900 may include a data storage 916, which may include non-volatile data storage. The data storage 916 stores any data used or generated by the configuration system 114.

The network interface 906 connects the computer system 900 to internal systems for example, via a LAN. Also, the network interface 906 may connect the computer system 900 to the Internet. For example, the computer system 900 may connect to web browsers and other external applications and systems via the network interface 906.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations of the present disclosure provide multiple technical improvements and address drawbacks of traditional software configuration methods, which are primarily manual. For example, implementations of the present disclosure provide efficient identification of configuration requirements. Such efficiency may directly lead to reduced time and computational requirements, thereby substantially reducing costs involved in configuring software (these costs are typically borne by the enterprise). Further, since many enterprises are increasingly configuring software, such cost reduction may result in increasing sustainability of such software and their operating environments.

Implementations of the present disclosure leverage multiple foundation models to enable automatic configuration of software packages via conversational interactions with the user. Thereby, saving computational time and resources by omitting manual implementation, resulting in a decrease in costs.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media, and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touchpad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer implemented method for generating configuration templates, comprising:
generating, by one or more processors, one or more conversational queries;
determining, by the one or more processors using a first foundation model, a task context, and a task intent based on one or more conversational responses to the one or more conversational queries to identify a set of software packages to configure to perform one or more tasks;
generating, by the one or more processors using a second foundation model, a workflow template for configuring a software package from the set of software packages, based on the task context, the task intent, and the one or more conversational responses;
refining, by the one or more processors using a third foundation model, configuration fields of the workflow template for subtasks of each task of the one or more tasks based on the one or more conversational responses; and
generating, by the one or more processors using a fourth foundation model, configuration fields of a configuration template for each task of the one or more tasks, based on the configuration fields of the workflow template and the one or more conversational responses for output.

2. The method of claim 1, further comprising: configuring software packages based on the configuration template for each task.

3. The method of claim 1, wherein the second foundation model is trained based on historical software configurations and corresponding task contexts and text intents.

4. The method of claim 1, further comprising: performing contextual and domain analysis on the task context and the task intent to identify the set of software packages to be configured.

5. The method of claim 1, wherein the second foundation model identifies configuration requirements for the software package based on the task context, task intent, and one or more conversational responses to generate the workflow template.

6. The method of claim 1, wherein the third foundation model refines the configuration fields of the workflow template by encoding dependencies using a graph neural network.

7. The method of claim 1, wherein the third foundation model refines the configuration fields of the workflow template by encoding dependencies based on at least one of: relationships between the task and the subtasks, historical intents, task context, and a domain.

8. The method of claim 7, wherein the configuration fields for the configuration templates for each task, of the one or more tasks, are generated based on the configuration fields of the workflow template.

9. An apparatus for generating configuration templates, comprising:
at least one memory; and
one or more processors coupled to the at least one memory and configured to:
generate one or more conversational queries;
determine, using a first foundation model, a task context, and a task intent based on one or more conversational responses to the one or more conversational queries to identify a set of software packages to configure to perform one or more tasks;
generate, using a second foundation model, a workflow template for configuring a software package from the set of software packages, based on the task context, task intent, and the one or more conversational responses;
refine, using a third foundation model, configuration fields of the workflow template for subtasks of each task based on the one or more conversational responses; and
generate, using a fourth foundation model, configuration fields of a configuration template for each task of the one or more tasks, based on the configuration fields of the workflow template and the one or more conversational responses for output.

10. The apparatus of claim 9, wherein the one or more processors are further configured to configure software packages based on the configuration template for each task.

11. The apparatus of claim 9, wherein the second foundation model is trained based on historical software configurations and corresponding task contexts and text intents.

12. The apparatus of claim 9, wherein the one or more processors are further configured to perform contextual and domain analysis on the task context and the task intent to identify the set of software packages to be configured.

13. The apparatus of claim 9, wherein the second foundation model identifies configuration requirements for the software package based on the task context, task intent, and one or more conversational responses to generate the workflow template.

14. The apparatus of claim 9, wherein to refine the configuration fields of the workflow template, the one or more processors are further configured to encode dependencies using a graph neural network.

15. The apparatus of claim 9, wherein, to refine the configuration fields of the workflow template, the one or more processors are further configured to use the third foundation model to encode dependencies based on at least one of: relationships between the task and the subtasks, historical intents, task context, and a domain.

16. The apparatus of claim 15, wherein the configuration fields for the configuration templates for each task, of the one or more tasks, are generated based on the configuration fields of the workflow template.

17. A non-transitory computer-readable medium having stored thereon instructions that, when executed by one or more processors, cause the one or more processors to:
generate one or more conversational queries;
determine, using a first foundation model, a task context, and a task intent based on one or more conversational responses to the one or more conversational queries to identify a set of software packages to configure to perform one or more tasks;
generate, using a second foundation model, a workflow template for configuring a software package from the set of software packages, based on the task context, task intent, and the one or more conversational responses;
refine, using a third foundation model, configuration fields of the workflow template for subtasks of each task based on the one or more conversational responses; and
generate, using a fourth foundation model, configuration fields of a configuration template for each task of the one or more tasks, based on the configuration fields of the workflow template and the one or more conversational responses for output.

18. The non-transitory computer-readable medium of claim 17, wherein the instructions cause the one or more processors to configure software packages based on the configuration template for each task.

19. The non-transitory computer-readable medium of claim 17, wherein the second foundation model is trained based on historical software configurations and corresponding task contexts and text intents.

20. The non-transitory computer-readable medium of claim 17, wherein the instructions cause the one or more processors to perform contextual and domain analysis on the task context and the task intent to identify the set of software packages to be configured.
